(19) United States
(12) Patent Application Publication
(10) Pub. No.: US 2025/0265826 A1
(43) Pub. Date: Aug. 21, 2025

(54) METHOD AND ELECTRONIC DEVICE FOR TRAINING A MACHINE LEARNING MODEL

(71) Applicant: SAMSUNG ELECTRONICS CO., LTD., Suwon-si (KR)

(72) Inventors: Ioannis MANIADIS METAXAS, Chertsey (GB); Adrian Bulat, Chertsey (GB); Brais Martinez Alonso, Chertsey (GB); Georgios Tzimiropoulos, Chertsey (GB)

(73) Assignee: SAMSUNG ELECTRONICS CO., LTD., Suwon-si (KR)

(21) Appl. No.: 19/204,303

(22) Filed: May 9, 2025

Related U.S. Application Data
(63) Continuation of application No. PCT/KR2023/015211, filed on Oct. 4, 2023.

(30) Foreign Application Priority Data
Nov. 9, 2022 (GR) 20220100923
Jul. 3, 2023 (GB) 2310140.5

(51) Int. Cl. G06V 10/774; G06V 10/762; G06V 10/77; G06V 10/82

(52) U.S. Cl. CPC G06V 10/7753; G06V 10/762; G06V 10/7715; G06V 10/82

(57) ABSTRACT

A computer-implemented method for training a machine learning, ML, model to perform object detection, the method comprising: obtaining a first training dataset comprising a plurality of unlabelled images, each unlabelled image containing at least one object; analysing the first training dataset by using an object detector module of the ML model; forming a second training dataset using the unlabelled images of the first training dataset and their corresponding extracted bounding boxes and pseudo-labels; and training the object detector module, using the second training dataset, to output bounding boxes and pseudo-labels for input pseudo-labelled images.

### CROSS REFERENCE TO RELATED APPLICATIONS

This is application is a Bypass Continuation of International Application No. PCT/KR2023/015211, filed Oct. 4, 2023, which claims benefit of Greek patent application No. 20220100923 filed on Nov. 9, 2022, and UK Patent Application No. 2310140.5 filed on Jul. 3, 2023, the disclosures of which are incorporated herein by reference in their entireties.

### TECHNICAL FIELD

The present application generally relates to a method and electronic device for training a machine learning, ML, model to perform object detection. In particular, the present application provides a method for unsupervised training of a machine learning, ML, model to perform object detection using unlabelled images.

### BACKGROUND ART

Object detection has been a major challenge in computer vision, and the focus of extensive research effort in order to improve the performance and generalization of models. A particular challenge has been the requirement for extensive dataset annotations, particularly given that, in real-life un-curated images, object annotations may be extremely dense and/or ambiguous. This issue has motivated research toward leveraging the success of self-supervised representation learning and extending it to object detection.

A recent breakthrough in object detection is the DEtection TRansformer (DETR), an end-to-end trainable single-stage detection framework that reformulates the task as direct set prediction, by-passing the use of hand-crafted components, such as non-maximum suppression or anchor generation. Despite these significant advantages, DETR has two important drawbacks, namely being sample-inefficient, requiring large amounts of extensively annotated data, and exhibiting slow training convergence. DETR-related follow-up works tackle these issues either through architectural changes or through self-supervised pretraining. However, despite the emergence of end-to-end trainable encoder-detector architectures such as DETR and its variants, an efficient, unified framework for self-supervised object detection training remains elusive.

The applicant has therefore identified the need for an improved method of training models to perform object detection.

### SUMMARY

In an embodiment of the present disclosure, a computer-implemented method for training, on a server, a machine learning, ML, model to perform object detection is provided. The method comprising: obtaining a first training dataset comprising a plurality of unlabelled images, each unlabelled image containing at least one object: extracting at least one bounding box for each unlabelled image by analysing the first training dataset: generating at least one pseudo-label for each of the at least one bounding box by analysing the first training dataset; forming a second training dataset by using the unlabelled images of the first training dataset, the at least one bounding box and the at least one pseudo-label; and training an object detector module, by using the second training dataset, to output the at least one bounding box and the at least one pseudo-label for input pseudo-labelled images.

In an embodiment of the present disclosure, an electronic device for training a machine learning, ML, model to perform object detection is provided. The electronic device comprising: a memory configured to store instructions; and at least one processor configured to execute the instructions to: obtain a first training dataset comprising a plurality of unlabelled images, each unlabelled image containing at least one object: extract at least one bounding box for each unlabelled image of the first training dataset by analysing the first training dataset; generate at least one pseudo-label for each of the at least one bounding box by analysing the first training dataset: form a second training dataset by using the unlabelled images of the first training dataset, the at least one bounding box and the at least one pseudo-label; and train the object detector module, by using the second training dataset, to output at the least one bounding box and the at least one pseudo-label for input pseudo-labelled images.

In an embodiment of the present disclosure, a computer-readable storage medium comprising instructions which, when executed by a processor, causes the processor to carry out the method is provided. The method comprising: obtaining a first training dataset comprising a plurality of unlabelled images, each unlabelled image containing at least one object: extracting at least one bounding box for each unlabelled image by analysing the first training dataset: generating at least one pseudo-label for each of the at least one bounding box by analysing the first training dataset: forming a second training dataset by using the unlabelled images of the first training dataset, the at least one bounding box and the at least one pseudo-label; and training an object detector module, by using the second training dataset, to output the at least one bounding box and the at least one pseudo-label for input pseudo-labelled images.

Additional aspects will be set forth in part in the description that follows and, in part, will be apparent from the description, or may be learned by practice of the presented embodiments of the disclosure.

### DESCRIPTION OF DRAWINGS

Implementations of the present disclosure will now be described, by way of example only, with reference to the accompanying drawings, in which:

FIG. 1 is a block diagram showing the main components of a method for training a machine learning, ML, model to perform image object detection.

FIG. 2 is a block diagram showing stage 1 of the training of the ML model.

FIG. 3 shows algorithm 1, which summarises the method shown in FIGS. 1 and 2.

FIG. 4 is a flowchart of example steps to train a ML model.

FIG. 5 is a block diagram of an electronic device for training a ML model.

FIG. 6 illustrates a method for training a ML model according to embodiments of the present disclosure.

### DETAILED DESCRIPTION

Broadly speaking, embodiments of the present disclosure provide a method for unsupervised training of a machine learning, ML, model to perform object detection using unlabelled images. In an embodiment, the unlabelled images may be images which are not tagged with labels identifying characteristics, properties or classifications.

The present disclosure adopt recently proposed, advanced DETR variants (such as VIDT+ and Deformable DETR) and focus on the important complementary aspect of self-supervised pretraining. These existing disclosure are briefly described below.

DETR and its variants: Transformer-based object detection architectures, introduced by DETR, deviate from previous methods such as by reformulating object detection as a set prediction problem with bipartite matching. This eliminates the need for hand-crafted components such as non-maximum suppression and a region-proposal network, producing a truly end-to-end object detection pipeline. However, despite its elegance and performance, DETR has been shown to suffer from limited sample efficiency and slow convergence. Subsequent works built on DETR to tackle these issues, such as by improving DETR's queries, by proposing improvements of the matching algorithm between queries and objects, by methods for making DETR more training-efficient, and by proposals for unifying the detector's backbone and encoder with a reconfigured attention module, achieving even further training speed and performance improvements. Despite significant progress, transformer-based detectors remain sample-inefficient, highlighting the complementary nature of unsupervised pretraining methods.

DETR pretraining: Despite significant progress made with novel architectures, DETR-based approaches require long training with a lot of data to achieve strong performance. Their effectiveness, therefore, depends on abundant, extensively annotated training samples. Despite the success of self-supervised backbone pretraining in object detection, few methods have been proposed for DETR pretraining. Notably, all of these works pretrain detectors in a class-unaware manner, relying on auxiliary objectives to improve their discriminative capacity. Furthermore, they all freeze the detector's backbone encoder during pretraining, as they suffer performance drops otherwise. This is a significant limitation, as it prevents true end-to-end self-supervised training, and makes such frameworks heavily dependent on the quality of the pretrained backbone.

Self-supervised learning for dense prediction downstream tasks: Recently, self-supervised learning has emerged as a powerful paradigm for learning representations from unlabelled visual data. Among such methods, a distinct line of research has focused on techniques for the self-supervised training of image encoders that better capture local information in images. Such encoders are particularly effective as backbones for detection/segmentation architectures, significantly improving their performance on the relevant dense prediction downstream tasks. Among self-supervised methods in this area, it is noted that some propose pretext tasks related to semantic segmentation, while others leverage object priors to formulate effective training objectives. However, it is important to note that the aforementioned works focus exclusively on training backbone encoders, not complete detection/segmentation architectures, and are not directly applicable to the training of end-to-end object detection pipelines. Furthermore, despite their usefulness in a wide array of downstream tasks, and their applicability to some dense prediction tasks such as semantic segmentation, backbones trained with these methods are not directly applicable to instance-level dense prediction tasks, and object detection in particular. These methods are, therefore, distinct from those that seek to pretrain detection architectures in a self-supervised, end-to-end manner.

Thus, there are few works for DETR pretraining, all of which have some quite important limitations. Their objectives focus on discriminating between object and non-object regions (i.e., localization task), ignoring class-related information, which is not well aligned with the downstream, class-aware detection task. Instead, they rely on a pretrained backbone to formulate distillation-based auxiliary tasks. As a consequence, the backbone needs to remain frozen during pretraining to avoid the degradation of its instance discrimination power. Finally, they are trained in a single-stage, ignoring potential benefits from iterative self-training which seems a natural fit for detection pretraining.

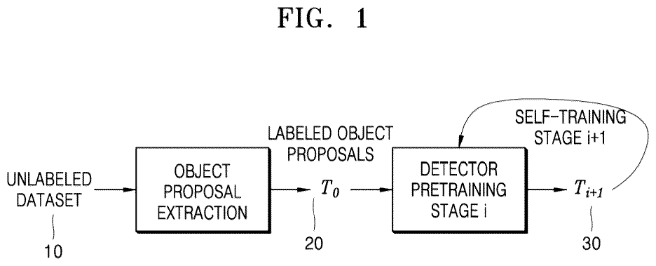

The present disclosure propose “SimDETR”, a simple framework for self-supervised pretraining for DETR which addresses the aforementioned limitations. FIG. 1 is a block diagram showing the main components of a method for training a machine learning, ML, model to perform image object detection using unlabelled images 10. In SimDETR, labelled object proposals 20 are extracted from images in an unsupervised manner and used to train a DETR-based detector. That detector then generates a new set of proposals 30, which are used for self-training.

The present disclosure comprise a number of components, as outlined in FIG. 1.

Firstly, the present disclosure enable improved pretraining with better initial object proposals, Specifically, rather than relying on random or hand-crafted object proposal methods, the proposals in SimDETR are obtained by clustering the feature map of each image, produced by a self-supervised pretrained backbone, in order to create a segmentation map, from which object proposals are extracted by identifying contiguous regions.

Secondly, the present disclosure enable class-aware pretraining via clustering. Proposals are clustered across the dataset based on their feature representation. The resulting cluster membership for each object proposal is then used as a pseudo-class label for standard, class-aware object detection training, resulting in alignment between the pretraining and downstream tasks.

Thirdly, the present disclosure enable iterative self-training. As the initial object proposals are not optimal, it is beneficial for detection pretraining to be applied in an iterative fashion, where the model is trained with pseudo-labels (bounding boxes and pseudo-class assignments) produced by the model itself in the previous round of training.

When all three components are used, it has been found that the pretraining is highly effective. The present disclosure have been demonstrated to provide a number of advantages. For example, the present disclosure provide improved detection accuracy. It is shown below that, without keeping the backbone frozen during pretraining, SimDETR consistently outperforms previous works on DETR pretraining by significant margin for both full and low data regimes. Specifically, SimDETR outperforms prior state of the art by +1.1 and +0.5 AP points on the full data with Def. DETR and VIDT+ respectively, and by +2.3 AP points in the challenging 1% semi-supervised setting. Furthermore, the present disclosure enable self-supervised representation learning from complex images. As SimDETR is amenable to end-to-end pretraining, it has been used to pretrain the whole model from scratch directly on complex images, demonstrating promising performance on detection but also on standard linear evaluation on ImageNet.

The present disclosure are now described in more detail. The present disclosure aim to simplify and better align the pretraining with respect to the downstream task (class-aware detection). To this end, object proposals are produced in the form of bounding boxes and class pseudo-label pairs in a totally unsupervised manner. A self-training strategy is then employed to pretrain and iteratively refine the detector.

Improving object proposals. A significant component of unsupervised pretraining is, invariably, its supervisory signal. For object detection, that is the object proposals used to train the detector. The present framework in particular would benefit from a robust set of proposals, with highly descriptive feature representations that can be used for meaningful pseudo-label assignments. From examining existing methods, it is noted that object discovery works generate very limited initial proposals to facilitate high precision. On the other hand, methods like Selective Search generate many proposals, but very noisy, as they rely on low-level priors such as colour and texture.

The present disclosure address this gap by proposing a method that produces rich object proposals, utilizing semantic information captured by self-supervised image encoders. Specifically, the present disclosure leverage a bi-level clustering strategy where the first level (termed local clustering) produces bounding box proposals and associated feature representations. The second level, termed global clustering, assigns class pseudo-labels to each proposal. The present method leads to diverse region proposals that is found to outperform previous methods and provide improved supervision for SimDETR.

Unsupervised proposal extraction: Given an input image X∈R^{3×H×W}, a self-supervised pretrained encoder is used to extract feature maps F₁∈R^{tl}^{₁}^{×H}^{₁}^{×W}^{₁} from each of the encoder's levels l. Given a feature map F, pixel-wise clustering is employed to group semantically-similar features. The Spectral Clustering algorithm may be used to this end. The clustering results in a set of masks M={mₖ}_{k=1:K}, where K represent the number of clusters, which is a user-defined parameter. In order to provide good coverage for all objects in the image, clustering is applied with different values K∈K and feature maps from different layers l∈L are used, leading to a set of masks M=U{M^{l,K}}_{K∈K,l∈L}.

Next, the different connected components of each mask are computed, leading to a set of regions R. Each region r∈R is then used to extract a bounding box (proposal) b and a corresponding feature vector f, where f is computed by average-pooling the last layer feature map Fₗ over r.

Proposal filtering: Due to the repeated clustering runs, the process described above leads to noisy and overlapping proposals. A number of filters are employed to refine them, including merging proposals that have a high intersection over union (IoU), proposals with highly-related semantic content, and proposals that are part of other proposals. This results in a set of N(i) bounding box-feature vector pairs for image i, {bₙ,fₙ}ₙ₌₁^{N(i)}.

Pseudo-class label generation: Proposals are then clustered across the whole dataset (global clustering) based on the feature vectors. That is, a single clustering round is performed on {fₙⁱ}_{n=1:N(i)}^{i=1:1}. Distributed K-Means clustering may be used in this case due to its high efficiency. Class membership is then used as the pseudo-class label, c∈C, for each of the proposals. This results in a training set T₀={Xᵢ,{(bₙⁱ,cₙⁱ}}.

Pretraining and Self-Training. The training set Ta can now be used to train an object detector within the DETR framework. In particular, given an input image and its corresponding extracted object proposals y, the network predicts a set ŷ={ŷ_{q}}_{q=1}^{Q}, where ŷ_{q}=(\hat{b}_{q}, ĉ_{q}), that is, the predicted bounding box and predicted category. It is noted that the extracted proposals y are padded to size Q with Ø (no object). Typically in DETR architectures, the ground truth and the predictions are put in correspondence via bipartite matching, formally defined as:

$$\hat{σ} = arg {min}_{σ ∈ {S}_{Q}} {\sum }_{q}^{Q} L ( {y}_{q} , {\hat{y}}_{σ ( q )} ) \qquad ( 1 )$$

where S_{Q} is the space of permutations of Q elements.

The loss between y and ŷ is computed as a combination of a bounding box matching loss and a class matching loss:

$${\sum }_{q = 1}^{Q} ( - log {\hat{p}}_{\hat{σ} ( q )} ( {c}_{q} ) + {1}_{( {c}_{q} \neq ⌀ )} {L}_{box} ( {b}_{q} , {b}_{\hat{σ} ( q )} ) ) \qquad ( 2 )$$

where \hat{p} indicates the predicted per-class probabilities. The indicator function 1_{c}_{ᵢ}_{≠Ø} represents that the box loss only applies to predictions that have been matched to object proposals y. Minimizing this loss results in weights Θ_{O}.

It is observed at this point that a detector trained in this way can localize more objects than those in the original proposals. Critically, this includes a larger number of small and more challenging objects and, therefore, offer a stronger supervisory signal. Thus, a new set of labels is generated for image i as {g(Xₗ:Θ₀)}, where g=(g_{b}, gₕ) are the detection network, backbone and detection head respectively. In standard self-training, pseudo-labels are filtered based on the classifier confidence. In the present disclosure, filtering based on the detector's confidence leads to the removal of small or challenging instances e.g. partially-occluded or uncommon objects. Thus, the present disclosure filter the new proposals so that any two boxes have an IoU lower than 0.55, with only the most confident box being kept when such conflicts exist. This leads to training set Tᵢ.

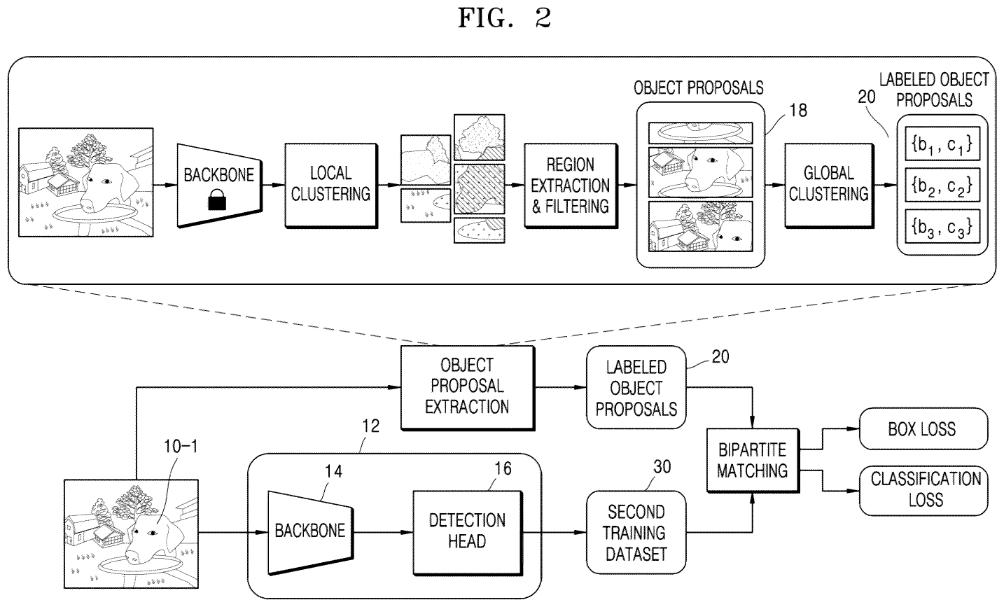

A new set of weights Θᵢ can be obtained by using training set Tᵢ and using Θᵢ₋₁ to initialize the weights. Simultaneously, Θᵢ can be used to generate a new training set Tᵢ₊₁. While this process can be iterated indefinitely, it has been observed that optimal performance involves just two rounds of training, which are referred to as Stages 1 & 2. Stage 1 training, including the proposal extraction process for Ta is shown in FIG. 2.

FIG. 2 is a block diagram showing stage 1 of the training of the machine learning, ML, model. The ML model comprises an object detector module 12. The object detector module 12 comprises a backbone neural network 14 and a detection head 16. The detection head 16 may be a transformer-based detector. A first training dataset 10 comprises a plurality of unlabelled images, each image depicting at least one object. The unlabelled images are used first to extract proposals for objects in each image—the proposals comprise a bounding box, i.e. a location within an image for an object, and a pseudo-label for the object within the bounding box. In FIG. 2, one image 10-1 from the first training dataset 10 is depicted as an example.

The method may comprise obtaining a first training dataset 10 comprising a plurality of unlabelled images, each image containing at least one object. The method may comprise analysing, in an unsupervised manner, the first training dataset by using the object detector module 12 of the ML model to: extract at least one bounding box 18 for each image 10-1; and generate a pseudo-label for each extracted bounding box 18. As explained in more detail below, extracting the bounding boxes may comprise filtering out noisy and overlapping bounding boxes. A global clustering technique may be performed to enable pseudo-labels to be generated for groups of bounding boxes. The method may further comprise: forming a second training dataset 30 using the images 10-1 of the first training dataset 10 and their corresponding proposals 20 (i.e. the extracted bounding boxes and pseudo-labels); and training the object detector module 12, using the second training dataset 30, to output bounding boxes and pseudo-labels for the input images.

Labelled region proposals are extracted at the start of training using a self-supervised pretrained backbone. Those proposals are then used to train the detector in a class-aware manner.

It is important to note that the proposed pretraining is very well-aligned with the downstream task, i.e. supervised class-aware object detection. Furthermore, the present disclosure enable pretraining of both the backbone and the detection head simultaneously. This is unlike other detector pretraining methods that require freezing the backbone to avoid performance degradation.

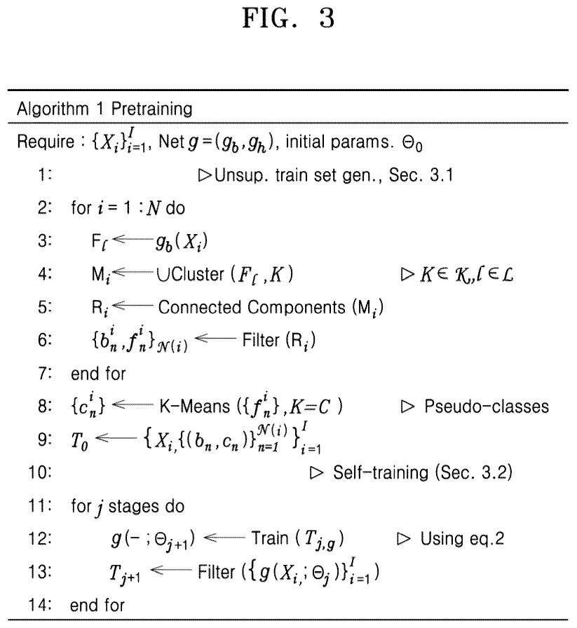

FIG. 3 shows algorithm 1, which summarises the method described above.

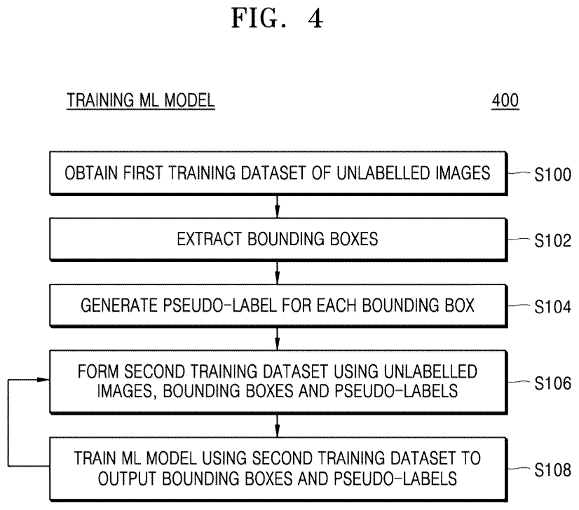

FIG. 4 is a flowchart of example steps to train a ML model to perform object detection. The training may be performed on-device or on server. Where the training is performed may depend on the size of the model and the capabilities/resources of the electronic device being used to perform the training (i.e. memory, processing power, etc.).

The method comprises: obtaining a first training dataset comprising a plurality of unlabelled and un-curated images, each image containing at least one object (step S100).

The method comprises analysing, in an unsupervised manner, the first training dataset by using an object detector module of the ML model to: extract at least one bounding box for each image (step S102), and generate a pseudo-label for each extracted bounding box (S104).

At step S102, analysing the first training dataset to extract at least one bounding box may comprise: using a pretrained encoder module of the ML model to extract feature map representations for each input unlabelled image; and using the feature maps/representations to extract a bounding box and to compute a corresponding feature vector.

As noted above, the method may comprise performing local clustering to cluster together the feature map representations for each input image. Then, global clustering may be performed over the dataset to generate pseudo-labels.

The present disclosure may use “local clustering”, which is applied to individual images of the first training dataset. Specifically, local clustering may be used to extract the bounding boxes from each image. Thus, step S102 of analysing the first training dataset to extract at least one bounding box from an unlabelled image may comprise: grouping together semantically-similar features in the extracted feature maps to form a set of masks: generating a set of regions by computing connected components of each mask of the set of masks; and extracting a bounding box from each region of the set of regions. Here, grouping together semantically-similar features may comprise using pixel-wise clustering. It will be understood that other clustering methods may be used for the bounding box extraction.

The first step toward extracting bounding boxes from those feature maps is to apply spectral clustering on them. To balance resolution with semantic meaningfulness, the two top-most feature maps are considered, with a downsampling factor of ×32 and ×16 respectively, relative to the original resolution of the image. Given that it is not known how many objects are contained/shown in each image, each image is clustered with different numbers of clusters k. Specifically, the top-most feature map, being more semantically meaningful, is clustered with k∈2,4,8, while the lower feature map is clustered with k∈8,16, to capture more, less dominant objects in the image. The resulting pixel-wise cluster assignments constitute segmentation masks in the pixel space, from which bounding boxes are extracted by identifying contiguous cluster regions. Importantly, at this stage, for each region proposal the pixel-wise representations of its assigned pixels are aggregated to produce feature vector representations corresponding to each region.

At step S104, analysing the first training dataset to generate a pseudo-label may comprise: grouping together the extracted bounding boxes from all the images in the first training dataset into a plurality of clusters, based on the feature vector of each bounding box; and generating a pseudo-label for the bounding box in each cluster. That is, the feature vectors associated with the bounding boxes are used to group together the bounding boxes across images, so that the grouped bounding boxes can be assigned the same pseudo-label. For example, bounding boxes may be provided around objects that look like dogs and objects that look like fruit. (It will be understood that the images in the first training dataset are not labelled with “dog” and “fruit” labels. Instead, the feature vectors indicate that all the bounding boxes that contain a dog seem to depict similar objects, and the same for the bounding boxes that contain a fruit.) The bounding boxes across images are grouped together in clusters based on the similarity of the feature vectors. In this way, the ML model groups together similar objects, and then applies a pseudo-label to each object in the cluster. The pseudo-label may not be the same as the actual label. Rather, the pseudo-label may simply be a label used to distinguish one object from another.

At step S102, grouping together the extracted bounding boxes into a plurality of clusters may comprise using distributed K-means clustering. This particular clustering method may be useful because it is highly efficient. However, it will be understood that other clustering methods may be used. This clustering may be considered “global clustering” because it is applied across the whole of the first training dataset.

Due to repeated local clustering steps to extract bounding boxes from the images of the first training dataset, the resulting bounding boxes may be noisy and/or overlapping. That is, as explained above, the bounding boxes are produced by an unsupervised process and so do not necessarily perfectly capture (i.e. surround) the actual objects in each image. This is referred to as ‘noise’ because when comparing the extracted bounding boxes to ground truth boxes, there will be a degree of deviation. Thus, it may be advantageous to employ a number of filters to refine the extracted bounding boxes.

In order to improve the numerous and noisy proposals resulting from the clustering process, a series of filters may be applied. Specifically: a) for each clustering, clusters with similar centroids are merged to avoid over-clustering, b) clusters that produce over 10 non-connected contiguous regions are considered noisy and discarded, c) between regions with identical bounding boxes (IOU>0.95), the smaller one is rejected, d) between pairs of regions with similar representations, if the smaller region is a subset of the larger one, remain, they undergo a last selection stage, where excess regions are discarded by order of diversity (considering both their boxes and segmentation masks) and size.

Thus, analysing the first training dataset to extract at least one bounding box from an unlabelled image may comprise: applying at least one filter to remove noisy bounding boxes (not shown in FIG. 4). Some example filters are now described.

Applying at least one filter may comprise: merging bounding boxes extracted from an unlabelled image which have a high degree of similarity based on an intersection over union, IoU, metric (e.g. an IoU distance). The IoU metric may be determined using k-means clustering.

Applying at least one filter may comprise: merging bounding boxes extracted from an unlabelled image which have highly-related semantic content. Thus, if multiple bounding boxes are provided for an image but they contain very similar content, then the bounding boxes are merged on the assumption that they contain similar or the same objects (such that they do not need to be processed separately).

Applying at least one filter may comprise: identifying two identical bounding boxes of an unlabelled image; and discarding one of the two bounding boxes that has a smaller area.

Applying at least one filter may comprise: identifying, for an unlabelled image, a first and a second bounding box having similar representations; and discarding the first bounding box when the first bounding box is a subset of the second bounding box.

Applying at least one filter may comprise: discarding, when there is more than a predefined number of bounding boxes for an unlabelled image, one or more bounding boxes based on diversity and size. That is, the bounding boxes may be filtered iteratively by finding, during each iteration, a pair of boxes with the highest overlap, where the degree of overlap is considered herein to indicate diversity. (High overlap means low diversity). The smaller box in the pair is then discarded. This iterative process is continued until the predefined number of boxes remain. For example in some cases, up to 25 proposal regions may be extracted for each image, with corresponding bounding boxes and feature vector representations (i.e. 25 is the predefined number in this example).

The method further comprises forming a second training dataset using the images of the first training dataset and their corresponding extracted bounding boxes and pseudo-labels (step S106). As noted above, once the proposals have been output from the object detector module, they can be used to form a second training dataset for training the ML model. Forming a second training dataset may comprise: generating augmented images using the images of the first training dataset.

Generating augmented images may comprise: combining two or more images from the first training dataset. The images may be combined in a mosaic-fashion, i.e. the images are arranged next to each other to form a larger image.

Using the labelled proposal regions extracted from Stage 1, a detector is trained using them as annotations and the assigned clusters as labels. Importantly, to improve the detector's performance in terms of both representation learning and object detection, during training a mosaic augmentation method may be used and/or strong colour augmentations. Regarding the mosaic augmentations in particular, some images are added with a lower resolution, artificially decreasing the area of their bounding boxes. This is done to overcome the bias in the first and second stage towards large objects, particularly during pre-training with object-centric data (e.g. ImageNet), and to motivate the detector to also generate small boxes as region proposals.

Generating augmented images may comprise changing a resolution of one or more images of the first training dataset. In some cases, the resolution of one or more of the two or more images being combined may be changed prior to the combining. For example, the resolution of the images may be reduced so that the training is performed using lower quality images.

Generating augmented images may comprise: altering a colour distribution of images from the first training dataset. In some cases, the colour distribution of one or more of the two or more images being combined may be changed prior to the combining.

The method comprises training the object detector module, using the second training dataset, to output bounding boxes and pseudo-labels for the input images (step S108). In an embodiment, the input images may be input pseudo-labelled images. The input pseudo-labelled images may be images labelled based on bounding boxes and pseudo-labels. Thus, new labelled region proposals are generated. The detector is then trained again (from scratch) using the new and improved annotations/labels, filtered according to their diversity and relative confidence. That is, unlike previous works on self-training, the present disclosure do not filter the new pseudo-labels using a confidence threshold. Instead, low confidence object proposals are kept and filtering is only performed to avoid overlapping proposals. For example, if multiple region proposals have an IOU over 0.55, only the most confident region proposal is kept.

Training the object detector module may comprise training a backbone network and a detection head of the ML model simultaneously. This is advantageous because it does not require the backbone network to be frozen while the detection head is trained. Freezing the backbone network during the training can cause performance degradation.

Object detectors generally produce numerous proposals with varying levels of confidence. Lower confidence proposals typically include smaller objects, which are harder to detect, and objects that were not included in the original training dataset. However, both of these (i.e. smaller objects and new objects) may be beneficial for the training of powerful detectors, so it is useful to retain lower confidence samples. Rather, the noisiness of the proposals is reduced by filtering out proposals that cover the same area, as explained above. For example, where two or more proposals have an IOU of over 0.55, only the proposal with the highest confidence is retained.

As shown in FIG. 4 by the arrow from step S108 to step S106, the output of step S108 may be used for further training. Thus, the method may further comprise: generating a further training dataset using the bounding boxes and pseudo-labels output during the training of the object detector module; and training the object detector module, using the further training dataset, to output bounding boxes and pseudo-labels for the input images. In other words, the output of the training may be used for further training, in an iterative manner.

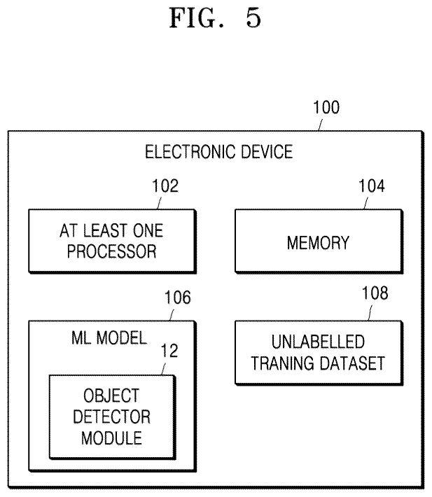

FIG. 5 is a block diagram of an electronic device 100 for training a ML model to perform object detection. The electronic device comprises: at least one processor 102 coupled to memory 104. The at least one processor 102 may comprise one or more of: a microprocessor, a microcontroller, and an integrated circuit. The memory 104 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The electronic device 100 comprises a ML model 106 for object detection. The ML model 106 comprises an object detector module 12, which has a backbone network and a detection head, as explained above. The electronic device 100 comprises an unlabelled training dataset 108.

The processor 102 is arranged for: obtaining a first training dataset 108 comprising a plurality of unlabelled images, each image containing at least one object; analysing, in an unsupervised manner, the first training dataset by using an object detector module 12 of the ML model to: extract at least one bounding box for each image; and generate a pseudo-label for each extracted bounding box: forming a second training dataset using the images of the first training dataset and their corresponding extracted bounding boxes and pseudo-labels; and training the object detector module 12, using the second training dataset, to output bounding boxes and pseudo-labels for the input images.

Experimental Setting. In order to compare with prior work on object detection pretraining, the process in DETReg is followed in terms of datasets, hyperparameters and experimental settings (namely, the full data and low data settings). In order to study the effectiveness of the present method for unsupervised representation learning, in the absence of a pre-defined protocol, the VIDT+ detector is used, and experiments are performed with the most well-established datasets in object detection.

Datasets: The following training sets are used for unsupervised pretraining: ImageNet, Open Images and MS COCO (COCO). COCO's training set (with annotations) is used for finetuning. Performance is reported on the COCO validation set, and average precision (AP) and average recall (AR) is used. ImageNet includes 1.2M object-centric images, classified with 1,000 labels and without object-level annotations. Open Images includes 1.7M scene-centric images, and a total of 14.6M bounding boxes with 600 object classes. COCO is a scene-centric dataset with 120K training images and 5K validation images containing 80 classes.

Architectures: The Deformable DETR and VIDT+ architectures are used in the experiments. Def. DETR is used to compare with prior work for detector pretraining. Following DETReg, a ResNet-50 backbone is used, initialized with SwAV, and pretrained on ImageNet. ViDT+ is the more recent of the two and the current state-of-the-art method, and is used to compare against unsupervised representation learning methods. Unless stated otherwise, its Swin-T transformer backbone is initialized with MoBY, which is pretrained on ImageNet. It is emphasised that, for both Def. DETR and VIDT+, their backbones were trained in a totally unsupervised manner.

Training & Hyperparameters: For Def. DETR, SimDETR is trained following DETReg. Specifically, the pretraining is performed for 5 epochs per stage on ImageNet with a batch size of 192 and finetuned on COCO for 50 epochs with a batch size of 32. The learning rate is 0.0002 and, for finetuning, is decreased by a factor of 10 at epoch 40.

For ViDT+, the training hyperparameters proposed by Song et al in the VIDT+ paper are used. Specifically, unless stated otherwise, VIDT+ is pretrained on ImageNet and Open Images for 10 epochs per stage and on COCO for 50 epochs per stage, with batch size 128. DETReg is pretrained for 20 epochs. Finetuning on COCO is done for 50 epochs with a batch size of 16. In all cases, the learning rate is set to 0.0001 and follows a cosine decay schedule. For SimDETR, unless stated otherwise, the number of region proposal classes is set to 2048.

Experiments. Two main results are highlighted, namely state-of-the-art results for detection pretraining and competitive results for self-supervised representation learning for detection, including pretraining on scene-centric data such as COCO from scratch. These results are complemented with a comprehensive set of ablation studies.

Object detection pretraining. In order to validate the present disclosure in terms of object detection pretraining, the benchmarks established by DETReg are closely followed. ViDT+ and Def. DETR are used as backbones and cover three settings, namely full data, semi-supervised and few-shot settings.

Full data regime: This setting pretrains DETR detectors on ImageNet and uses COCO's training set for supervised finetuning. COCO's validation set is used for evaluation. A set of comparisons with competing detector pretraining methods are provided in Table 1 below. The lower section of Table 1 shows results for detection pretraining methods, with pretraining using ImageNet and finetuning using COCO. The upper section shows unsupervised pretraining methods for detection, typically on non-DETR detector architectures.

TABLE 1

| | | | | | | | |
|---|---|---|---|---|---|---|---|
| | | Backbone | Detector | Frozen | | | |
| Detector | Backbone | Pretraining | Pretraining | Backbone | AP | AP₅₀ | AP₇₅ |

Unsupervised representation learning for detection

| | | | | | | | |
|---|---|---|---|---|---|---|---|
| Mask- | ResNet50 | Supervised^{†} | — | — | 39.6 | — | — |
| RCNN (x1) | | DenseCL | | | 40.3 | 59.9 | 44.3 |
| | | SwAV | | | 41.6 | — | — |
| | | UniVIP | | | 41.6 | — | — |
| Mask- | ResNet50 | Supervised^{†} | — | — | 41.6 | — | — |
| RCNN (x2) | | MoCo v2 | | | 41.7 | — | — |
| | | SimCLR | | | 41.6 | — | — |
| | | DINO | | | 42.3 | — | — |
| | | BYOL | | | 42.4 | — | — |
| | | SlotCon | | | 42.6 | 62.7 | 46.2 |
| | | UniVIP | | | 43.1 | — | — |
| | | DetCon₈ | | | 43.4 | — | — |
| | | Odin | | | 43.8 | — | — |
| FCOS* | ResNet50 | Supervised^{†} | — | — | 44.2 | — | — |
| | | DetCon₈ | | | 45.4 | — | — |
| | | Odin | | | 45.6 | — | — |
| | Swin-T | Supervised^{†} | — | — | 46.7 | — | — |
| | | MoBY | | | 47.6 | — | — |
| | | DetCon₈ | | | 48.4 | — | — |
| | | Odin | | | 48.5 | — | — |
| ViDT+ | Swin-T | MoBY | — | — | 48.3 | 66.9 | 52.4 |
| | | SimDETR^{‡} | | | 48.8 | 67.4 | 53.1 |

DETR-based detector pretraining

| | | | | | | | |
|---|---|---|---|---|---|---|---|
| Def. DETR | ResNet50 | Supervised^{†} | — | — | 44.5 | 63.6 | 48.7 |
| | | SwAV | — | — | 45.2 | 64.0 | 49.5 |
| | | SwAV | UP-DETR | ✓ | 44.7 | 63.7 | 48.6 |
| | | SwAV | DETReg | ✓ | 45.5 | 64.1 | 49.9 |
| | | SwAV | JoinDet | ✓ | 45.6 | 64.3 | 49.8 |
| | | SwAV | SimDETR | x | 46.7 | 65.4 | 50.9 |
| ViDT+ | Swin-T | MoBY | — | — | 48.3 | 66.9 | 52.4 |
| | | MoBY | DETReg | ✓ | 49.1 | 67.4 | 53.1 |
| | | MoBY | DETReg | x | 47.8 | 65.9 | 52.0 |
| | | MoBY | SimDETR | x | 49.6 | 68.2 | 53.8 |

In Table 1-†: Backbone trained on ImageNet with labels, and #: Backbone initialized with MoBY and pretrained with SimDETR (detection head was discarded). Interestingly, all prior work requires freezing the backbone. The impact of this requirement was quantitatively assessed by making the DETReg backbone trainable. It can be seen from Table 1 that a steep performance degradation was observed. Contrary to all the existing works, SimDETR supports a trainable backbone due to its better alignment of pretraining and downstream tasks. Thus, for completeness, Table 1 also includes results from other self-supervised representation learning methods that focus on backbone-pretraining for detection, irrespective of whether they are within the DETR framework.

As Table 1 shows, the present disclosure (SimDETR) significantly outperform competing DETR pretraining methods with both detector architectures. Furthermore, the present disclosure also achieve the highest performance among self-supervised learning methods for detection.

Semi-supervised setting: In this protocol pretraining is conducted on the COCO training set, while k % samples of the training set are subsequently used for finetuning. Results in Table 2 demonstrate that SimDETR outperforms previous works by significant margins, particularly in the more challenging settings with fewer labelled samples.

TABLE 2

| | AP | | | |
|---|---|---|---|---|
| Method | 1% | 2% | 5% | 10% |
| SwAV | 11.79 ± 0.3 | 16.02 ± 0.4 | 22.81 ± 0.3 | 27.79 ± 0.2 |
| DETReg | 14.58 ± 0.3 | 18.69 ± 0.2 | 24.80 ± 0.2 | 29.12 ± 0.2 |
| JoinDet | 15.89 ± 0.2 | — | — | 30.87 ± 0.1 |
| SimDETR | 18.19 ± 0.1 | 21.80 ± 0.2 | 26.90 ± 0.2 | 30.97 ± 0.2 |

Few-shot setting: Detectors are pretrained on ImageNet and finetuned on COCO, on only k∈(10,30) instances per class. As DETReg does not provide implementation details for this setting, their published checkpoint is used, training for 100 epochs. Results are presented in Table 3 and demonstrate that the present disclosure again outperform DETReg.

TABLE 3

| | |
|---|---|
| Novel AP | Novel AP₇₅ |

| Method | Detector | 10 | 30 | 10 | 30 |
|---|---|---|---|---|---|
| DETReg | Def. | 2.9 | 8.8 | 3.0 | 9.5 |
| SimDETR | DETR | 10.9 | 17.2 | 8.7 | 18.4 |

Self-supervised representation learning on scene-centric images: The ability of the present disclosure to learn a self-supervised representation (i.e., train a backbone) that is suitable for detection is examined. First, it is validated that SimDETR trained on scene-centric data (e.g. COCO) can perform competitively compared to ImageNet pretraining. Then, SimDETR is used directly for self-supervised representation learning on scene-centric data (i.e., training from scratch on COCO/Open Images), showing promising results. Finally, it is shown that pretraining on COCO leads to a representation that transfers to ImageNet under the linear-probe setting.

Object vs Scene-centric pretraining: In the full data experiments above, prior literature was followed and the pretraining was performed using object-centric data (ImageNet). In this section, it is examined whether the present disclosure can achieve competitive performance by pretraining on scene-centric datasets instead. To that end, VIDT+ is pretrained on COCO and Open Images, keeping the initialization settings described above. For Open Images, pretraining is performed in two stages, each for 10 epochs. For COCO, the training is performed instead for 50 epochs per stage to compensate for the comparatively smaller size. Finetuning is then performed on COCO's training set, and results on its validation set are presented. These results are shown in Table 4. The class-unaware object detection performance is also reported in terms of average recall (AR) as it hints at different behaviours between the two settings in this regard.

TABLE 4

| Dataset | Stage | AP | AP₅₀ | AP₇₅ | AR¹⁰⁰ |
|---|---|---|---|---|---|
| — | MoBY | 48.3 | 66.9 | 52.4 | — |
| COCO | Stage 1 | 48.8 | 67.6 | 53.0 | 23.9 |
| ImageNet | | 48.9 | 67.4 | 52.9 | 25.9 |
| Open-Images | | 48.9 | 67.5 | 52.9 | 24.5 |
| COCO | Stage 2 | 49.1 | 67.8 | 53.1 | 25.1 |
| ImageNet | | 49.6 | 68.2 | 53.8 | 27.1 |
| Open Images | | 49.4 | 67.9 | 53.9 | 25.5 |

It is observed that, in all cases, the present method improves over the baseline, even pretraining on COCO, where pretraining and finetuning is performed on the same set of data. Stage 1 achieves similar results on all datasets, a significant finding which shows that SimDETR is: a) sample efficient, achieving similar performance pretraining on COCO and on the larger ImageNet and Open Images datasets, and b) flexible, being able to handle both object-centric and scene-centric data. In Stage 2, while all datasets improve over Stage 1, Open Images outperforms COCO, indicating that, with enough training time, pretraining on a larger dataset is impactful. Furthermore, ImageNet pretraining outperforms the two scene-centric datasets, although by a small margin in the case of Open Images. This difference is attributed to the relative quality of the object proposals produced for self-training. As seen by contrasting AR scores in Table 4, ImageNet's Stage 1 detector localizes more objects correctly, which likely leads to improved outcomes when self-training. Overall, these results indicate that SimDETR does not require carefully curated object-centric data to achieve competitive results.

Self-supervised representation learning on scene-centric data: Experiments conducted in previous sections uniformly initialize the backbone with weights obtained by self-supervised training on ImageNet. In this section, the representation learning capacity of SimDETR is evaluated by pretraining a VIDT+ detector from an untrained backbone (from scratch). The goal is to examine whether independent backbone pretraining is indeed necessary. The present model is pretrained and finetuned on COCO, where the pretraining is performed for 1K epochs per stage. Results in Table 5 show that the present model performs evenly with a detector whose backbone was pretrained on ImageNet, despite ImageNet having 10× as many samples and being object-centric. This outcome supports the hypothesis that unsupervised pretraining directly on scene-centric data with an object detection task is feasible and can be effective.

Table 5 shows the results of pretraining on COCO. SimDETR is pretrained on COCO without backbone initialization, and then finetuned on COCO. The table shows results on the COCO validation set. For comparison, VIDT+ is finetuned with random initialization and with a backbone pretrained with MoBY on ImageNet. Furthermore, results are provided for DetCon and SlotCon, that perform self-supervised (backbone-only) COCO pretraining, noting they use a ResNet50 backbone and Mask-RCNN detector.

TABLE 5

| Backbone | Detector | | | |
|---|---|---|---|---|
| Pretraining | Pretraining | AP | AP₅₀ | AP₇₅ |
| MoBY | — | 48.3 | 66.9 | 52.4 |
| DetCon | — | 33.4 | — | — |
| SlotCon | — | 41.0 | — | — |
| — | — | 38.5 | 55.4 | 41.2 |
| — | SimDETR | 48.3 | 66.8 | 52.4 |

Furthermore, the quality of the COCO-pretrained backbone is evaluated by performing a linear-probe experiment on ImageNet, i.e. the backbone is kept frozen and only the classifier is trained. Table 6 shows SimDETR's performance as well as that of prior work. SimDETR is pre-trained with VIDT+ on COCO's train set, and the backbone is applied to linear evaluation on ImageNet. Results reported on ImageNet's validation set. It is noted however that prior work uses a ResNet50 encoder and thus a direct comparison is hard (VIDT+ requires a transformer backbone). It is however clear that the present method is competitive despite being pretrained for object detection, highlighting the natural fit of SimDETR for general-purpose representation learning from scene-centric images.

TABLE 6

| Backbone Pretraining | Acc |
|---|---|
| DenseCL | 49.9 |
| VirTex | 53.8 |
| MoCo | 49.8 |
| Van Gansbeke et al. | 56.1 |
| SimDETR | 56.4 |

Analysis and ablations. Throughout this section, ViDT+ is used and, unless stated otherwise, pretraining is performed using ImageNet for 10 epochs per stage.

Impact of object proposals: First, the proposals are evaluated in terms of the number of objects they localize by computing the average recall (AR) on COCO's validation set. The initial proposals are evaluated (noted as SimDETR-St. 0), as well as subsequent proposals, i.e. the proposals generated during the self-training stage. A comparison is made with Selective Search and recent unsupervised object discovery frameworks in Table 7. Table 7 shows the quality of proposals, i.e. AR results on COCO's validation set. The upper section of Table 7 shows methods for the initial extraction of object proposals. The lower section shows proposals generated by detection/segmentation architectures trained on the initial proposals. Results show that detector pretraining significantly improves over the initial proposals, justifying the decision to self-train. It is also clear that SimDETR achieves higher recall than comparable methods. Diminishing gains between Stages 1 and 2 are also noticed.

TABLE 7

| Object | Detection | |
|---|---|---|
| proposals | Architecture | AR¹⁰⁰ |
| Sel. Search | — | 10.9 |
| SimDETR-St. 0 | — | 13.4 |
| DETReg | Def. DETR | 12.7 |
| FreeSOLO | SOLO | 15.3 |
| MOVE | MOVE | 15.9 |
| JoinDet | Def. DETR | 17.4 |
| SimDETR-St. 1 | ViDT+ | 25.9 |
| SimDETR-St. 2 | ViDT+ | 27.1 |

Second, in order to investigate the importance of the present object proposal method for SimDETR, proposals extracted via Selective Search (up to 30 per image, following DETReg) are used, and the global clustering step is applied to produce the required pseudo-labels. Results are presented in Table 8, which shows AP results on COCO's validation set, using different initial object proposal methods. A performance drop is observed when using Selective Search instead of the present proposals, most notably in Stage 2, despite still improving over the baseline. The improved performance of the present proposal extraction method is attributed to two reasons: a) the class pseudo-labels for Selective Search proposals are likely worse than that of the present method, which produces more discriminative proposal descriptors by only aggregating semantically related pixels, and b) the present proposals are fewer but more robust (up to 25 per image with higher AR), which provides better supervision, particularly for the self-training stage. In summary, it is concluded that SimDETR is robust to different object proposals methods, but it greatly benefits from an appropriate method choice.

TABLE 8

| Method | Proposals | AP | AP₅₀ | AP₇₅ |
|---|---|---|---|---|
| MoBY | — | 48.3 | 66.9 | 52.4 |
| SimDETR-St. 1 | Sel. Search | 48.7 | 67.3 | 52.7 |
| SimDETR-St. 2 | | 48.6 | 67.1 | 52.2 |
| SimDETR-St. 1 | Our Anns. | 48.9 | 67.4 | 52.9 |
| SimDETR-St. 2 | | 49.6 | 68.2 | 53.8 |

number of clusters during global clustering of object proposals. For this set of experiments, pretraining and finetuning is performed on COCO's training set for 25 epochs each. Note this is a simplified (and cheaper) setting for the purpose of ablating. Using COCO's validation set, the training accuracy (ACC), the class-agnostic average recall (AR) score, and the AP scores after finetuning are provided in Table 9. In the table, the 1 class entry implies class-unaware pretraining. It is found that increasing the number of classes generally improves the pretrained detector's downstream performance, as evidenced by the improved AP scores Table 9, while simultaneously leading to decreased ACC (which is expected, since the classification task becomes harder as the number of classes grows larger) and AR, which indicates unsupervised detection performance. Overall, it is observed that the present method seems to be robust to the number of clusters chosen.

TABLE 9

| Classes | ACC | AR | AP |
|---|---|---|---|
| 1 | — | 25.2 | 41.2 |
| 256 | 80.01 | 23.9 | 43.8 |
| 512 | 75.13 | 24.0 | 43.9 |
| 2048 | 53.75 | 23.9 | 44.1 |

Self-training stages: Table 10 examines the impact of self-training. The table shows AP results for ViDT+ pretrained with SimDETR on ImageNet and finetuned on COCO. Average proposals per image are measured during training. It is observed that, while a second training stage produces meaningful gains, additional self-training rounds are not useful.

TABLE 10

| | | | | Avg. |
|---|---|---|---|---|
| Stage | AP | AP₅₀ | AP₇₅ | Proposals/Image |
| 1 | 48.9 | 67.4 | 52.9 | 36.5 |
| 2 | 49.6 | 68.2 | 53.8 | 54.5 |
| 3 | 49.6 | 68.0 | 53.9 | 71.7 |

Schedule length: In Table 11, the impact of a longer training schedule on the present method for both training stages is examined, by extending training from 10 to 25 epochs per stage. The table shows AP results for varying training epochs. 10- and 25-epoch Stage 2 models are initialized from 10- and 25-epoch Stage 1 models respectively. The results show that a longer training schedule can have some beneficial, yet marginal, effect. Interestingly, Table 11 highlights the importance of self-training, as two training stages totaling a combined 20 epochs (10 per stage) clearly outperform a single training round of 25 epochs.

TABLE 11

| Stage | Epochs | AP | AP50 | AP75 |
|---|---|---|---|---|
| 1 | 10 | 48.9 | 67.4 | 52.9 |
| 1 | 25 | 49.2 | 67.7 | 53.6 |
| 2 | 10 | 49.6 | 68.2 | 53.8 |
| 2 | 25 | 49.7 | 68.1 | 54.2 |

Thus, the present disclosure provide SimDETR, a novel method for self-supervised pretraining of an end-to-end object detector. Compared to prior work, the present disclosure align pretraining and downstream tasks through the careful construction of pseudo-labels and the use of self-training. Extensive evaluation of SimDETR in typical object detector pretraining benchmarks demonstrates that it consistently outperforms previous methods. However, unlike prior work, it is shown that SimDETR is also capable of effectively pretraining the backbone. This brings the present method in line with the wider literature on self-supervised representation learning for detection. Again, competitive performance in this area is shown and novel settings are explored, specifically pretraining with scene-centric datasets and even pretraining from scratch. Overall, it can be seen that the present disclosure not only outperform existing DETR pretraining methods, but also represent a promising step toward self-supervised, fully end-to-end object detection pretraining on un-curated images.

### REFERENCES

DETR-Nicolas Carion, Francisco Massa, Gabriel Synnaeve, Nicolas Usunier, Alexander Kirillov, and Sergey Zagoruyko. End-to-end object detection with transformers. In European conference on computer vision, 2020
Spectral Clustering algorithm-Andrew Ng, Michael Jordan, and Yair Weiss. On spectral clustering: Analysis and an algorithm. Advances in neural information processing systems, 2001
Distributed K-Means clustering-Mathilde Caron, Ishan Misra, Julien Mairal, Priya Goyal, Piotr Bojanowski, and Armand Joulin. Unsupervised learning of visual features by contrasting cluster assignments. In Advances in neural information processing systems, 2020
ImageNet-Olga Russakovsky, Jia Deng, Hao Su, Jonathan Krause, Sanjeev Satheesh, Sean Ma, Zhiheng Huang, Andrej Karpathy, Aditya Khosla, Michael Bernstein, Alexander C. Berg, and Fei-Fei Li. ImageNet large scale visual recognition challenge. International Journal on Computer Vision, 2015.
Open Images-Ivan Krasin, Tom Duerig, Neil Alldrin, Vittorio Ferrari, Sami Abu-El-Haija, Alina Kuznetsova, Hassan Rom, Jasper Uijlings, Stefan Popov, Shahab Kamali, Matteo Malloci, Jordi Pont-Tuset, Andreas Veit, Serge Belongie, Victor Gomes, Abhinav Gupta, Chen Sun, Gal Chechik, David Cai, Zheyun Feng, Dhyanesh Narayanan, and Kevin Murphy. Openimages: A public dataset for large-scale multi-label and multi-class image classification. Dataset available from https://storage.googleapis.com/openimages/web/index.html, 2017.
MS COCO (“COCO”)-Tsung-Yi Lin, Michael Maire, Serge Belongie, James Hays, Pietro Perona, Deva Ramanan, Piotr Doll′ar, and C Lawrence Zitnick. Microsoft COCO: Common objects in context. In European conference on computer vision, 2014.
Deformable DETR (“Def. DETR”)—Xizhou Zhu, Weijie Su, Lewei Lu, Bin Li, Xiaogang Wang, and Jifeng Dai. Deformable DETR: Deformable transformers for end-to-end object detection. International Conference on Learning Representations, 2021.
VIDT+—Hwanjun Song, Deqing Sun, Sanghyuk Chun, Varun Jampani, Dongyoon Han, Byeongho Heo, Wonjae Kim, and Ming-Hsuan Yang. An extendable, efficient and effective transformer-based object detector. arXiv preprint arXiv: 2204.07962, 2022.
VIDT—Hwanjun Song, Deqing Sun, Sanghyuk Chun, Varun Jampani, Dongyoon Han, Byeongho Heo, Wonjae Kim, and Ming-Hsuan Yang. ViDT: An efficient and effective fully transformer-based object detector. In International Conference on Learning Representations, 2022
DETReg—Amir Bar, Xin Wang, Vadim Kantorov, Colorado J Reed, Roei Herzig, Gal Chechik, Anna Rohrbach, Trevor Darrell, and Amir Globerson. DETReg: Unsupervised pretraining with region priors for object detection. In IEEE/CVF Conference on Computer Vision and Pattern Recognition, 2022.
ResNet-50—Kaiming He, Xiangyu Zhang, Shaoqing Ren, and Jian Sun. Deep residual learning for image recognition. In IEEE/CVF Conference on Computer Vision and Pattern Recognition, 2016.
SwAV—Mathilde Caron, Ishan Misra, Julien Mairal, Priya Goyal, Piotr Bojanowski, and Armand Joulin. Unsupervised learning of visual features by contrasting cluster assignments. In Advances in neural information processing systems, 2020.
MoBY—Zhenda Xie, Yutong Lin, Zhuliang Yao, Zheng Zhang, Qi Dai, Yue Cao, and Han Hu. Self-supervised learning with swin transformers. arXiv preprint arXiv: 2105.04553, 2021
Mask-RCNN—Kaiming He, Georgia Gkioxari, Piotr Doll'ar, and Ross Girshick. Mask R-CNN. In IEEE/CVF International Conference on Computer Vision, 2017
FCOS—Zhi Tian, Chunhua Shen, Hao Chen, and Tong He. FCOS: Fully convolutional one-stage object detection. In IEEE/CVF International Conference on Computer Vision, 2019.
DenseCL—Xinlong Wang, Rufeng Zhang, Chunhua Shen, Tao Kong, and Lei Li. Dense contrastive learning for self-supervised visual pre-training. In IEEE/CVF Conference on Computer Vision and Pattern Recognition, 2021
UniVIP—Zhaowen Li, Yousong Zhu, Fan Yang, Wei Li, Chaoyang Zhao, Yingying Chen, Zhiyang Chen, Jiahao Xie, Liwei Wu, Rui Zhao, et al. Univip: A unified framework for self-supervised visual pre-training. In Proceedings of the IEEE/CVF Conference on Computer Vision and Pattern Recognition, pages 14627-14636, 2022
MoCo v2—Xinlei Chen, Haoqi Fan, Ross Girshick, and Kaiming He. Improved baselines with momentum contrastive learning. arXiv preprint arXiv: 2003.04297, 2020
SimCLR—Ting Chen, Simon Komblith, Mohammad Norouzi, and Geoffrey Hinton. A simple framework for contrastive learning of visual representations. In International Conference on Machine Learning, 2020
DINO—Mathilde Caron, Hugo Touvron, Ishan Misra, Herv'e J'egou, Julien Mairal, Piotr Bojanowski, and Armand Joulin. Emerging properties in self-supervised vision transformers. In IEEE/CVF International Conference on Computer Vision, 2021.
BYOL—Jean-Bastien Grill, Florian Strub, Florent Altch'e, Corentin Tallec, Pierre Richemond, Elena Buchatskaya, Carl Doersch, Bernardo Avila Pires, Zhaohan Guo, Mohammad Gheshlaghi Azar, et al. Bootstrap your own latent-a new approach to self-supervised learning. Advances in neural information processing systems, 2020
SlotCon—XinWen, Bingchen Zhao, Anlin Zheng, Xiangyu Zhang, and Xiaojuan Qi. Self-supervised visual representation learning with semantic grouping. In Advances in neural information processing systems, 2022
DetConB—Olivier J H'enaff, Skanda Koppula, Jean-Baptiste Alayrac, Aaron Van den Oord, Oriol Vinyals, and Joao Carreira. Efficient visual pretraining with contrastive detection. In IEEE/CVF International Conference on Computer Vision, 2021
Odin—Olivier J. H′enaff, Skanda Koppula, Evan Shelhamer, Daniel Zoran, Andrew Jaegle, Andrew Zisserman, Joao Carreira, and Relja Arandjelovic. Object discovery and representation networks. In European conference on computer vision, 2022.
UP-DETR—Zhigang Dai, Bolun Cai, Yugeng Lin, and Junying Chen. UP-DETR: Unsupervised pre-training for object detection with transformers. In IEEE/CVF Conference on Computer Vision and Pattern Recognition, 2021
JoinDet—Yizhou Wang, Meilin Chen, Shixiang Tang, Feng Zhu, Haiyang Yang, Lei Bai, Rui Zhao, Yunfeng Yan, Donglian Qi, and Wanli Ouyang. Unsupervised object detection pretraining with joint object priors generation and detector learning. In Advances in neural information processing systems, 2022.
Swin-T—Ze Liu, Yutong Lin, Yue Cao, Han Hu, Yixuan Wei, Zheng Zhang, Stephen Lin, and Baining Guo. Swin transformer: Hierarchical vision transformer using shifted windows. In IEEE/CVF International Conference on Computer Vision, 2021
VirTex—Karan Desai and Justin Johnson. Virtex: Learning visual representations from textual annotations. In Proceedings of the IEEE/CVF conference on computer vision and pattern recognition, 2021
Van Gansbeke et al—Wouter Van Gansbeke, Simon Vandenhende, Stamatios Georgoulis, and Luc V Gool. Revisiting contrastive methods for unsupervised learning of visual representations. Advances in Neural Information Processing Systems, 2021.
FreeSOLO—Xinlong Wang, Zhiding Yu, Shalini De Mello, Jan Kautz, Anima Anandkumar, Chunhua Shen, and Jose M Alvarez. Freesolo: Learning to segment objects without annotations. In IEEE/CVF Conference on Computer Vision and Pattern Recognition,
MOVE—Adam Bielski and Paolo Favaro. Move: Unsupervised movable object segmentation and detection. arXiv preprint arXiv: 2210.07920, 2022

Those skilled in the art will appreciate that while the foregoing has described what is considered to be the best mode and where appropriate other modes of performing present disclosure, the present disclosure should not be limited to the specific configurations and methods disclosed in this description of the preferred embodiment. Those skilled in the art will recognise that present disclosure have a broad range of applications, and that the embodiments may take a wide range of modifications without departing from any inventive concept as defined in the appended claims.

In an embodiment of the present disclosure, there is provided a computer-implemented method for training, on a server, a machine learning, ML, model to perform object detection, the method comprising: obtaining a first training dataset comprising a plurality of unlabelled images, each unlabelled image containing at least one object: analysing (in an unsupervised manner) the first training dataset by using an object detector module of the ML model to: extract at least one bounding box for each unlabelled image; and generate a pseudo-label for each extracted bounding box: forming a second training dataset using the unlabelled images of the first training dataset and their corresponding extracted bounding boxes and pseudo-labels; and training the object detector module, using the second training dataset, to output bounding boxes and pseudo-labels for the input pseudo-labelled images.

Advantageously, the present disclosure use an untrained object detector module of the ML model to obtain proposals for the location of an object and a class or label of the object, and then use these proposals to train the object detector module. Thus, the present disclosure are useful in cases where there is insufficient labelled image data. The present disclosure also provide a training method which is better aligned with the downstream task that the trained model is to perform, i.e. class-aware object detection.

The analysis of the first training data set is preferably performed in a totally unsupervised manner. That is, object proposals are produced by the analysis in the form of bounding boxes and class pseudo-label pairs in a totally unsupervised manner. This means that no human intervention is used to guide the placement of the bounding boxes or to assign pseudo-labels to the bounding boxes. The pseudo-label generated for each extracted bounding box may not be the same as the actual label. Rather, the pseudo-label may simply be a label used to distinguish one object from another. For example, if a bounding box contains an image of a cat, the pseudo-label may be “ABC1” rather than “cat”, because the pseudo-label is simply used to distinguish this object (i.e. the cat) from other objects, and not to actually classify the object.

Training the object detector module may comprise training a backbone network and a detection head of the ML model simultaneously. This is advantageous because it does not require the backbone network to be frozen while the detection head is trained. Freezing the backbone network during the training can cause performance degradation.

Analysing the first training dataset to extract at least one bounding box may comprise: using a pretrained encoder module of the ML model to extract at least one feature map for each input unlabelled image; and using the at least one feature map to extract a bounding box and to compute a corresponding feature vector. Feature maps or activation maps are generated using feature detectors or filters that help identify different features present in an image, like edges, vertical lines, horizontal lines, bends, etc. A feature map is the output of a convolutional layer representing specific features in the input image.

Analysing the first training dataset to generate a pseudo-label may comprise: grouping together the extracted bounding boxes from all the unlabelled images in the first training dataset into a plurality of clusters, based on the feature vector of each bounding box: and generating a pseudo-label for the bounding box in each cluster. That is, the feature vectors associated with the bounding boxes are used to group together the bounding boxes across images, so that the grouped bounding boxes (i.e. a cluster) can be assigned the same pseudo-label. For example, bounding boxes may be provided around objects that look like dogs and objects that look like fruit. (It will be understood that the images in the first training dataset are not labelled with “dog” and “fruit” labels. Instead, the feature vectors indicate that all the bounding boxes that contain a dog seem to depict similar objects, and the same for the bounding boxes that contain a fruit.) The bounding boxes across images are grouped together in clusters based on the similarity of the feature vectors. In this way, the ML model groups together similar objects, and then applies a pseudo-label to each object in the cluster. The pseudo-label may not be the same as the actual label. Rather, the pseudo-label may simply be a label used to distinguish one object from another.

Grouping together the extracted bounding boxes into a plurality of clusters may comprise using distributed K-means clustering. This particular clustering method may be useful because it is highly efficient. However, it will be understood that other clustering methods may be used. This clustering may be considered “global clustering” because it is applied across the whole of the first training dataset.

The present disclosure may also use “local clustering”, which is applied to individual unlabelled images of the first training dataset. Specifically, local clustering may be used to extract the bounding boxes from each unlabelled image. Thus, processing the first training dataset to extract at least one bounding box from an unlabelled image may comprise: grouping together semantically-similar features in the extracted feature maps to form a set of segmentation masks: generating a set of regions by computing connected components of each mask of the set of masks; and extracting a bounding box from each region of the set of regions. Here, grouping together semantically-similar features may comprise using pixel-wise clustering. It will be understood that other clustering methods may be used for the bounding box extraction. Semantically-similar features are those which are close in terms of a semantic distance, as opposed to visual distance. That is, some objects may look different (i.e. be visually different) but may be the same or similar object (i.e. be semantically similar). For example, an image of an orange may look different to an image showing multiple oranges in a fruit bowl, but they are semantically similar. In contrast, the image of an orange may look quite similar to an image of the sun (as they are both orange and circular), but they are semantically very different.

As noted above, generating a set of regions comprises computing connected components of each mask of the set of masks. That is, connected component segmentation is performed to determine whether two neighbouring pixels belong to the same segment/region. This could be based on, for example, the colour and/or intensity of the pixels.

Due to repeated local clustering steps to extract bounding boxes from the images of the first training dataset, the resulting bounding boxes may be noisy and/or overlapping. That is, the bounding boxes are produced by an unsupervised process and so do not necessarily perfectly capture (i.e. surround) the actual objects in each image. This is referred to as ‘noise’ because when comparing the extracted bounding boxes to ground truth boxes, there will be a degree of deviation. Thus, it is advantageous to employ a number of filters or other disclosure to refine the extracted bounding boxes. The refining of the extracted bounding boxes may result in fewer bounding boxes. Thus, analysing the first training dataset to extract at least one bounding box from an unlabelled image may comprise: applying at least one filter to remove noisy bounding boxes. Some example filters are now described.

Applying at least one filter may comprise: merging bounding boxes extracted from an unlabelled image which have a high degree of similarity based on an intersection over union, IoU, metric (e.g. an IoU distance). The IoU metric may be determined using k-means clustering.

Applying at least one filter may comprise: merging bounding boxes extracted from an unlabelled image which have highly-related semantic content. Thus, if multiple bounding boxes are provided for an image but they contain very similar content, then the bounding boxes are merged on the assumption that they contain similar or the same objects (such that they do not need to be processed separately).

Applying at least one filter may comprise: identifying two identical bounding boxes of an unlabelled image; and discarding one of the two bounding boxes that has a smaller area.

Applying at least one filter may comprise: identifying, for an unlabelled image, a first and a second bounding box having similar feature representations; and discarding the first bounding box when the first bounding box is a subset of the second bounding box, i.e. when the first bounding box is located within the second bounding box.

Applying at least one filter may comprise: discarding, when there is more than a predefined number of bounding boxes for an unlabelled image, one or more bounding boxes based on diversity and size, i.e. based on degree of overlap between the bounding boxes and the size of the bounding boxes. That is, the bounding boxes may be filtered iteratively by finding, during each iteration, a pair of boxes with the highest overlap, where the degree of overlap is considered herein to indicate diversity. (High overlap means low diversity). The smaller box in the pair is then discarded. This iterative process is continued until the predefined number of boxes remain. This process may be applied after one or more other filters has been applied.

As noted above, once the proposals have been output from the object detector module, they can be used to form a second training dataset for training the ML model. The second training dataset may be formed by augmenting images. That is, forming a second training dataset may comprise: generating augmented images using the images of the first training dataset. Augmented images are artificially created versions of the original images of the first training dataset that are created by, for example, performing transformations (e.g. shifts, rotations, colour, etc.), clipping, changing the resolution, blurring, adding overlapping objects, merging images, and so on.

Generating augmented images may comprise: combining two or more images from the first training dataset. The images may be combined in a mosaic-fashion, i.e. the images are arranged next to each other to form a larger image.

Generating augmented images may comprise changing a resolution of one or more images of the first training dataset. In some cases, the resolution of one or more of the two or more images being combined may be changed prior to the combining. For example, the resolution of the images may be reduced so that the training is performed using lower quality images.

Generating augmented images may comprise: altering a colour distribution of one or more images from the first training dataset. In some cases, the colour distribution of one or more of the two or more images being combined may be changed prior to the combining.

The method may further comprise: generating a further training dataset using the bounding boxes and pseudo-labels output during the training of the object detector module; and further training the object detector module, using the further training dataset, to output bounding boxes and pseudo-labels for the input images. In other words, the output of the training may be used for further training, in an iterative manner.

In a second approach of the present disclosure, there is provided an apparatus for training a machine learning, ML, model to perform object detection, the apparatus comprising: at least one processor coupled to memory, for: obtaining a first training dataset comprising a plurality of unlabelled images, each image containing at least one object: analysing, in an unsupervised manner, the first training dataset by using an object detector module of the ML model to: extract at least one bounding box for each image; and generate a pseudo-label for each extracted bounding box: forming a second training dataset using the images of the first training dataset and their corresponding extracted bounding boxes and pseudo-labels; and training the object detector module, using the second training dataset, to output bounding boxes and pseudo-labels for the input pseudo-labelled images.

The features described above with respect to the first approach apply equally to the second approach and therefore, for the sake of conciseness, are not repeated.

In a related approach of the present disclosure, there is provided a computer-readable storage medium comprising instructions which, when executed by a processor, causes the processor to carry out any of the methods described herein.

As will be appreciated by one skilled in the art, the present disclosure may be embodied as a system, method or computer program product. Accordingly, present disclosure may take the form of an entirely hardware embodiment, an entirely software embodiment, or an embodiment combining software and hardware aspects.

Furthermore, the present disclosure may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present disclosure may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present disclosure also provide a non-transitory data carrier carrying code which, when implemented on a processor, causes the processor to carry out any of the methods described herein.

The disclosure further provide processor control code to implement the above-described methods, for example on a general purpose computer system or on a digital signal processor (DSP). The disclosure also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the disclosure described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The disclosure may comprise a controller which includes a microprocessor, working memory and program memory coupled to one or more of the components of the system.

It will also be clear to one of skill in the art that all or part of a logical method according to embodiments of the present disclosure may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present disclosure may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present disclosure may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

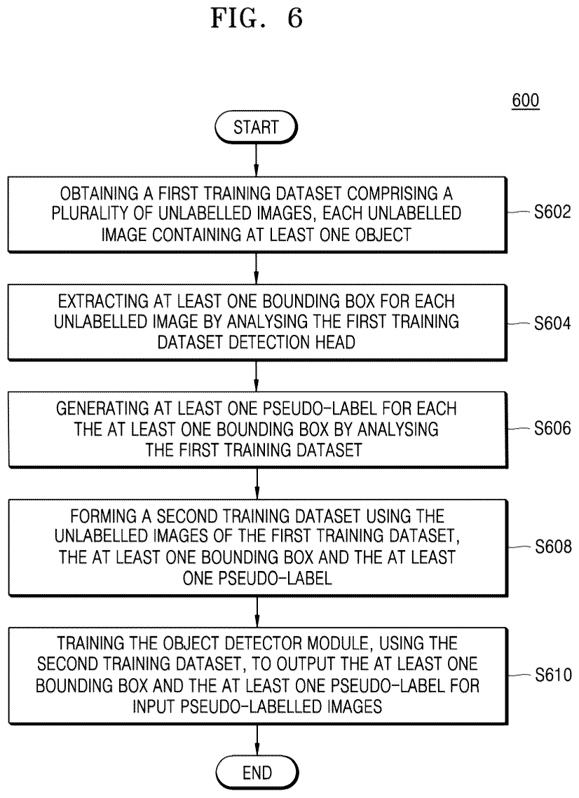

FIG. 6 illustrates a method 600 for training a ML model according to embodiments of the present disclosure.

As shown in FIG. 6, In accordance with an aspect of the disclosure, a computer-implemented method 600 for training a machine learning, ML, model to perform object detection is provided. The method 600 may include obtaining S602 a first training dataset comprising a plurality of unlabelled images, each unlabelled image containing at least one object: extracting S604 at least one bounding box for each unlabelled image by analysing the first training dataset: generating S606 at least one pseudo-label for each of the at least one bounding box by analysing the first training dataset: forming S608 a second training dataset by using the unlabelled images of the first training dataset, the at least one bounding box and the at least one pseudo-label; and training S610 an object detector module, by using the second training dataset, to output the at least one bounding box and the at least one pseudo-label for input pseudo-labelled images.

In accordance with an aspect of the disclosure, the training S610 the object detector module comprises training a backbone network and a detection head of the ML model simultaneously.

In accordance with an aspect of the disclosure, extracting S604 the at least one bounding box comprises using a pretrained encoder module of the ML model to extract at least one feature map for each unlabelled image and using the at least one feature map to extract the at least one bounding box and to compute a corresponding feature vector.

In accordance with an aspect of the disclosure, generating S606 the at least one pseudo-label comprises grouping together the at least one bounding box from all the images in the first training dataset into a plurality of clusters, based on the feature vector of each of the at least one bounding box and generating the at least one pseudo-label for the at least one bounding box in each cluster.

In accordance with an aspect of the disclosure, the grouping together the at least one bounding box into a plurality of clusters comprises using distributed K-means clustering.

In accordance with an aspect of the disclosure, extracting S604 the at least one bounding box from an unlabelled image comprises grouping together semantically-similar features in the extracted feature maps to form a set of masks generating a set of regions by computing connected components of each mask of the set of masks and extracting the at least one bounding box from each region of the set of regions. In accordance with an aspect of the disclosure, the grouping together semantically-similar features comprises using pixel-wise clustering.

In accordance with an aspect of the disclosure, extracting S604 the at least one bounding box from an unlabelled image comprises: applying at least one filter to remove noisy bounding boxes.

In accordance with an aspect of the disclosure, the applying the at least one filter comprises merging the at least one bounding box extracted from an unlabelled image based on a similarity obtained by an Intersection over Union, IoU, metric.

In accordance with an aspect of the disclosure, the applying the at least one filter comprises: merging the at least one bounding box extracted from an unlabelled image based on a semantic content.

In accordance with an aspect of the disclosure, the applying the at least one filter comprises: identifying two identical bounding boxes of an unlabelled image and discarding one of the two bounding boxes that has a smaller area.

In accordance with an aspect of the disclosure, the applying at least one filter comprises: identifying, for an unlabelled image, a first bounding box and a second bounding box based on feature representations and discarding the first bounding box when the first bounding box is located within the second bounding box.

In accordance with an aspect of the disclosure, the applying at least one filter comprises: discarding, when there is more than a predefined number of bounding boxes for an unlabelled image, one or more bounding boxes based on degree of overlap between the bounding boxes and the size of the bounding boxes.

In accordance with an aspect of the disclosure, an electronic device for training a machine learning, ML, model to perform object detection, is provided. The electronic device comprising: memory configured to store instructions and at least one processor configured to execute the instructions to: obtain a first training dataset comprising a plurality of unlabelled images, each unlabelled image containing at least one object: extract at least one bounding box for each unlabelled image of the first training dataset by analysing the first training dataset; generate at least one pseudo-label for each of the at least one bounding box by analysing the first training dataset: form a second training dataset by using the unlabelled images of the first training dataset, the at least one bounding box and the at least one pseudo-label; and train an object detector module, by using the second training dataset, to output at the least one bounding box and the at least one pseudo-label for input pseudo-labelled images.

In accordance with an aspect of the disclosure, a computer-readable storage medium comprising instructions which, when executed by a processor, causes the processor to carry out the method 600 is provided. The method may include obtaining S602 a first training dataset comprising a plurality of unlabelled images, each unlabelled image containing at least one object: extracting S604 at least one bounding box for each unlabelled image by analysing the first training dataset: generating S606 at least one pseudo-label for each of the at least one bounding box by analysing the first training dataset: forming S608 a second training dataset by using the unlabelled images of the first training dataset, the at least one bounding box and the at least one pseudo-label; and training S610 an object detector module, by using the second training dataset, to output the at least one bounding box and the at least one pseudo-label for input pseudo-labelled images.

What is claimed is:

1. A computer-implemented method for training a machine learning, ML, model to perform object detection, the method comprising:
obtaining a first training dataset comprising a plurality of unlabelled images, each unlabelled image containing at least one object;
extracting at least one bounding box for each unlabelled image by analysing the first training dataset;
generating at least one pseudo-label for each of the at least one bounding box by analysing the first training dataset;
forming a second training dataset by using the unlabelled images of the first training dataset, the at least one bounding box and the at least one pseudo-label; and
training an object detector module, by using the second training dataset, to output the at least one bounding box and the at least one pseudo-label for input pseudo-labelled images.

2. The method of claim 1, wherein the training the object detector module comprises training a backbone network and a detection head simultaneously.

3. The method of claim 1, wherein the extracting the at least one bounding box comprises:
using a pretrained encoder module to extract at least one feature map for each unlabelled image; and
using the at least one feature map to extract the at least one bounding box and to compute a corresponding feature vector.

4. The method of claim 1, wherein the generating the at least one pseudo-label comprises:
grouping together the at least one bounding box from all the images in the first training dataset into a plurality of clusters, based on the feature vector of each of the at least one bounding box; and
generating the at least one pseudo-label for the at least one bounding box in each cluster.

5. The method of claim 4, wherein the grouping together the at least one bounding box into a plurality of clusters comprises using distributed K-means clustering.

6. The method of claim 3, wherein the extracting the at least one bounding box from an unlabelled image comprises:
grouping together semantically-similar features in the extracted feature maps to form a set of masks;
generating a set of regions by computing connected components of each mask of the set of masks; and
extracting the at least one bounding box from each region of the set of regions.

7. The method of claim 6, wherein the grouping together semantically-similar features comprises using pixel-wise clustering.

8. The method of claim 1, wherein the extracting the at least one bounding box from an unlabelled image comprises:
applying at least one filter to remove noisy bounding boxes.

9. The method of claim 8, wherein the applying the at least one filter comprises:
merging the at least one bounding box extracted from an unlabelled image based on a similarity.

10. The method of claim 8, wherein the applying the at least one filter comprises:
merging the at least one bounding box extracted from an unlabelled image based on a semantic content.

11. The method of claim 8, wherein the applying the at least one filter comprises:
identifying two identical bounding boxes of an unlabelled image; and
discarding one of the two bounding boxes that has a smaller area.

12. The method of claim 8, wherein the applying at least one filter comprises:
identifying, for an unlabelled image, a first bounding box and a second bounding box based on feature representations; and
discarding the first bounding box when the first bounding box is located within the second bounding box.

13. The method of claim 8, wherein the applying at least one filter comprises:
discarding, when there is more than a predefined number of bounding boxes for an unlabelled image, one or more bounding boxes based on degree of overlap between the bounding boxes and the size of the bounding boxes.

14. An electronic device for training a machine learning, ML, model to perform object detection, the electronic device comprising:
a memory configured to store instructions; and
at least one processor configured to execute the instructions to:
obtain a first training dataset comprising a plurality of unlabelled images, each unlabelled image containing at least one object;
extract at least one bounding box for each unlabelled image of the first training dataset by analysing the first training dataset;
generate at least one pseudo-label for each of the at least one bounding box by analysing the first training dataset;
form a second training dataset by using the unlabelled images of the first training dataset, the at least one bounding box and the at least one pseudo-label; and
train an object detector module, by using the second training dataset, to output at the least one bounding box and the at least one pseudo-label for input pseudo-labelled images.

15. The electronic device of claim 14, wherein the at least one processor configured to execute the instructions to:
training a backbone network and a detection head simultaneously.

16. The electronic device of claim 14, wherein the at least one processor configured to execute the instructions to:
use a pretrained encoder module to extract at least one feature map for each unlabelled image; and
use the at least one feature map to extract the at least one bounding box and to compute a corresponding feature vector.

17. The electronic device of claim 14, wherein the at least one processor configured to execute the instructions to:
group together the at least one bounding box from all the images in the first training dataset into a plurality of clusters, based on the feature vector of each of the at least one bounding box; and
generate the at least one pseudo-label for the at least one bounding box in each cluster.

18. The electronic device of claim 17, wherein the at least one processor configured to execute the instructions to:
use distributed K-means clustering to group together the at least one bounding box into the plurality of clusters.

19. The electronic device of claim 16, wherein the at least one processor configured to execute the instructions to:
group together semantically-similar features in the extracted feature maps to form a set of masks;
generate a set of regions by computing connected components of each mask of the set of masks; and
extract the at least one bounding box from each region of the set of regions.

20. A computer-readable storage medium comprising instructions which, when executed by a processor, causes the processor to carry out the method for training a machine learning, ML, model to perform object detection, the method comprising:
obtaining a first training dataset comprising a plurality of unlabelled images, each unlabelled image containing at least one object;
extracting at least one bounding box for each unlabelled image by analysing the first training dataset;
generating at least one pseudo-label for each of the at least one bounding box by analysing the first training dataset;
forming a second training dataset by using the unlabelled images of the first training dataset, the at least one bounding box and the at least one pseudo-label; and
training an object detector module, by using the second training dataset, to output the at least one bounding box and the at least one pseudo-label for input pseudo-labelled images.
